(19) United States
(12) Patent Application Publication
(10) Pub. No.: US 2019/0130809 A1
(43) Pub. Date: May 2, 2019

(54) Panel Display Position Fine Adjustment Method

(71) Applicant: Raydium Semiconductor Corporation, Hsinchu (TW)

(72) Inventors: JUN-REN SHIH, Hsinchu City (TW); SHANG-PING TANG, Zhubei City (TW); TZONG-YAU KU, Hsinchu City (TW)

(21) Appl. No.: 16/178,717

(22) Filed: Nov. 2, 2018

Related U.S. Application Data
(60) Provisional application No. 62/580,498, filed on Nov. 2, 2017.

(51) Int. Cl. G09G 3/20

(52) U.S. Cl. CPC G09G 3/20; G09G 2310/08; G09G 2310/0264

(57) ABSTRACT

A panel display position fine adjustment method is disclosed. The panel display position fine adjustment method includes steps of: (a) providing a fixed first synchronization timing signal; (b) generating a first control signal, a second control signal, and a third control signal according to the first synchronization timing signal, wherein the second control signal is turned on earlier than the first control signal and the third control signal is turned on later than the first control signal; (c) when the first display driver is controlled by the first control signal, the display area is not moved; (d) when the first display driver is controlled by the second control signal, the display area is moved in the first direction; and (e) when the first display driver is controlled by the third control signal, the display area is moved in the second direction opposite to the first direction.

### BACKGROUND OF THE INVENTION

### 1. Field of the Invention

The invention relates to a display; in particular, to a panel display position fine adjustment method.

### 2. Description of the Prior Art

In the application of micro display, because the size of the pixel is very small (<10 um), in order to accurately position the display region in the mechanical assembly, it is usually necessary to use a very high precision alignment machine.

However, once the alignment of the display region of the micro display is inaccurate, not only the yield of production is seriously affected, but also the micro display may cause problems when displaying image.

### SUMMARY OF THE INVENTION

Therefore, the invention provides a panel display position fine adjustment method to solve the above-mentioned problems

A preferred embodiment of the invention is a panel display position fine adjustment method. In this embodiment, the panel display position fine adjustment method is applied to a panel including a display region. The panel is coupled to a first display driver. The panel display position fine adjustment method includes steps of: (a) providing a fixed first synchronization timing signal; (b) generating a first control signal, a second control signal, and a third control signal according to the first synchronization timing signal, wherein the second control signal is turned on earlier than the first control signal and the third control signal is turned on later than the first control signal; (c) when the first display driver is controlled by the first control signal, the display area is not moved; (d) when the first display driver is controlled by the second control signal, the display area is moved in the first direction; and (e) when the first display driver is controlled by the third control signal, the display area is moved in the second direction opposite to the first direction.

In an embodiment, the first display driver is a gate driver.

In an embodiment, the first synchronization timing signal is a vertical synchronization timing signal.

In an embodiment, the first direction is toward a bottom of the panel and the second direction is toward a top of the panel.

In an embodiment, a distance that the display region moves along the first direction in the step (d) is equal to a distance that the display region moves along the second direction in the step (e).

In an embodiment, the panel is further coupled to a second display driver, the panel display position fine adjustment method further includes steps of: (0 providing a fixed second synchronization timing signal; (g) generating a fourth control signal, a fifth control signal and a sixth control signal according to the second synchronization timing signal, wherein the fifth control signal is turned on earlier than the fourth control signal and the sixth control signal is turned on later than the fourth control signal; (h) when the second display driver is controlled by the fourth control signal, the display area being not moved; (i) when the second display driver is controlled by the fifth control signal, the display area being moved in a third direction; and (j) when the second display driver is controlled by the sixth control signal, the display area being moved in a fourth direction opposite to the third direction.

In an embodiment, the second display driver is a source driver.

In an embodiment, the second synchronization timing signal is a horizontal synchronization timing signal.

In an embodiment, the third direction is toward a right side of the panel and the second direction is toward a left side of the panel.

In an embodiment, a distance that the display region moves along the third direction in the step (i) is equal to a distance that the display region moves along the fourth direction in the step (j).

In an embodiment, the panel display position fine adjustment method further includes a step of: providing a fixed effective data region timing signal.

Compared to the prior art, the panel display position fine adjustment method of the invention can finely adjust the position of the display region in the up, down, left and right directions, so that the display region deviation caused by the inaccuracy of the conventional micro display can be effectively improved, thereby when the micro display displays image, the problems caused by the influence of the display region offset can be avoided.

The advantage and spirit of the invention may be understood by the following detailed descriptions together with the appended drawings.

### BRIEF DESCRIPTION OF THE APPENDED DRAWINGS

FIG. 1 illustrates a schematic diagram of providing a fixed first synchronization timing signal, a fixed second synchronization timing signal and a fixed effective data region timing signal.

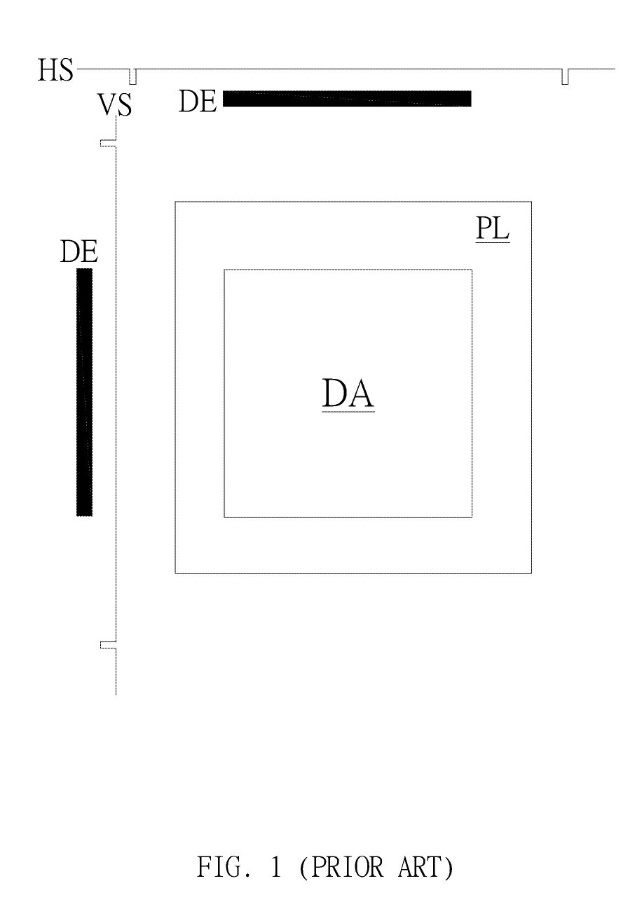

FIG. 2 illustrates a flowchart of the panel display position fine adjustment method in a preferred embodiment of the invention.

FIG. 3 illustrates a schematic diagram of generating a first control signal, a second control signal, and a third control signal according to the first synchronization timing signal to control the operation of the first display driver to make the display region not move, move down and move up respectively.

FIG. 4 illustrates a flowchart of the panel display position fine adjustment method in another preferred embodiment of the invention.

FIG. 5 illustrates a schematic diagram of generating a fourth control signal, a fifth control signal, and a sixth control signal according to the second synchronization timing signal to control the operation of the second display driver to make the display region not move, move right and move left respectively.

### DETAILED DESCRIPTION OF THE INVENTION

An embodiment of the invention is a panel display position fine adjustment method can effectively improve the display region deviation caused by the inaccuracy of the conventional micro display, thereby the yield can be effectively increased and the problems caused by the influence of the display region offset can be avoided when the micro display displays image.

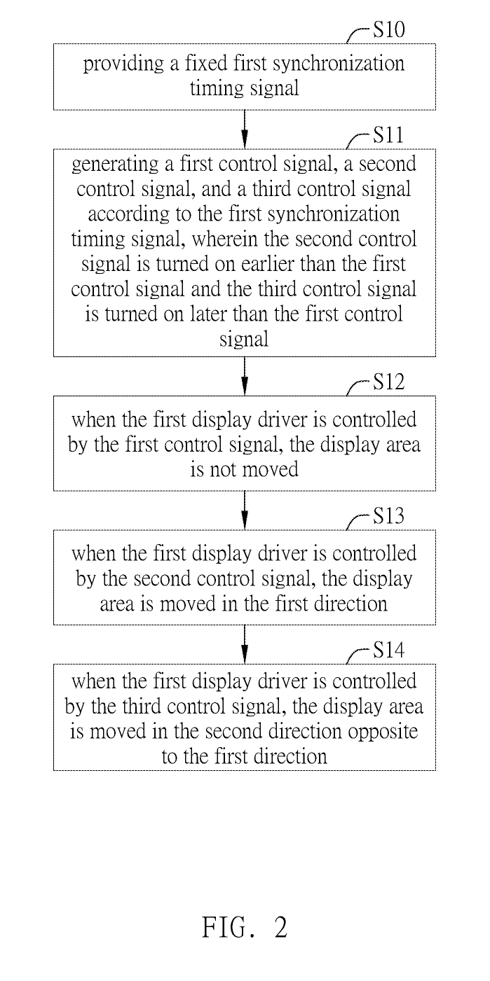

Please refer to FIG. 2. FIG. 2 illustrates a flowchart of the panel display position fine adjustment method in this embodiment. It should be noticed that the panel display position fine adjustment method is applied to a panel including a display region. The panel is coupled to a first display driver (e.g., a gate driver, but not limited to this).

As shown in FIG. 2, the panel display position fine adjustment method includes the following steps of:

Step S10: providing a fixed first synchronization timing signal;

Step S11: generating a first control signal, a second control signal, and a third control signal according to the first synchronization timing signal, wherein the second control signal is turned on earlier than the first control signal and the third control signal is turned on later than the first control signal;

Step S12: when the first display driver is controlled by the first control signal, the display area is not moved;

Step S13: when the first display driver is controlled by the second control signal, the display area is moved in the first direction; and

Step S14: when the first display driver is controlled by the third control signal, the display area is moved in the second direction opposite to the first direction.

In practical applications, the first display driver can be a gate driver; the first synchronization timing signal can be a vertical synchronization timing signal; the first direction is toward the bottom of the panel and the second direction is toward the top of the panel; The distance in which the display region in step S13 moves along the first direction is equal to the distance in which the display region in step S14 moves along the second direction.

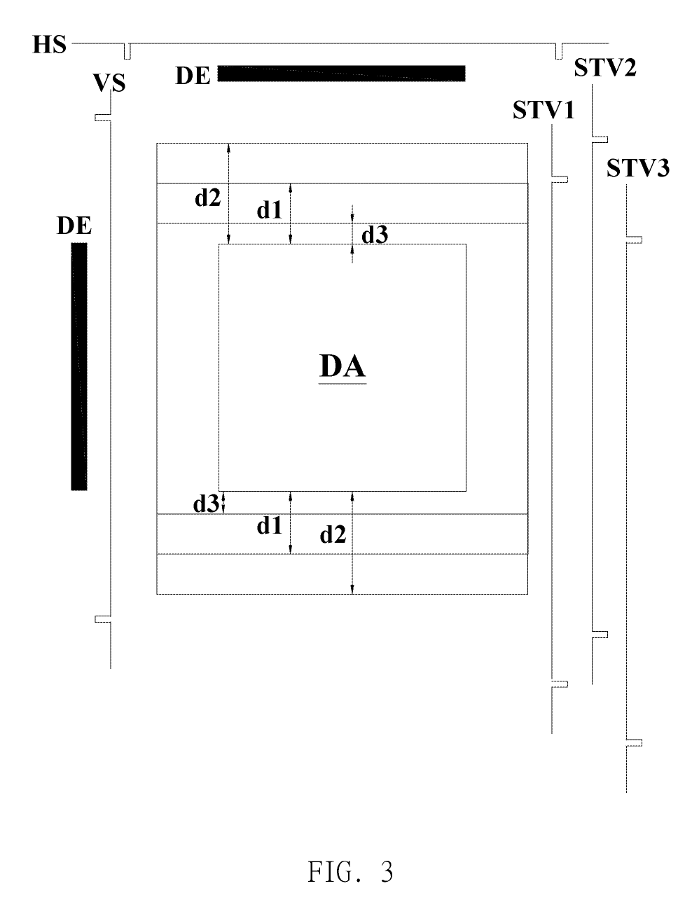

For example, please refer to FIG. 3. FIG. 3 illustrates a schematic diagram of generating a first control signal, a second control signal, and a third control signal according to the first synchronization timing signal to control the operation of the first display driver to make the display region not move, move down and move up respectively.

As shown in FIG. 3, assuming that the timing controller in the display can provide a fixed first synchronization timing signal VS, the panel display position fine adjustment method generates the first control signal STV1, the second control signal STV2 and the third control signal STV3 according to the first synchronization timing signal VS respectively. Assuming that the time is increased from the top to the bottom, the on-time of the second control signal STV2 is earlier than the on-time of the first control signal STV1 and the on-time of the third control signal STV3 is later than the on-time of the first control signal STV1.

When the first display driver (e.g., the gate driver) is turned on controlled by the on-time of the first control signal STV1, the first display driver (e.g., the gate driver) is turned on at a distance d1 (e.g., 12 horizontal lines) before the valid data region timing signal DE; that is to say, when the first display driver (e.g., the gate driver) is turned on, the valid data region is displayed after 12 horizontal lines, which is the normal display region, so the display region DA does not move.

When the first display driver (e.g., the gate driver) is turned on controlled by the on-time of the second control signal STV2, the first display driver (e.g., the gate driver) is turned on at a distance d2 (e.g., 24 horizontal lines) before the valid data region timing signal DE; that is to say, when the first display driver (e.g., the gate driver) is turned on, the valid data region is displayed after 24 horizontal lines, which moves 12 horizontal lines downward from the normal display region, so that the display region DA moves downward, and the position of the display region DA can be fine-tuned downward.

When the first display driver (e.g., the gate driver) is turned on controlled by the on-time of the third control signal STV3, the first display driver (e.g., the gate driver) is turned on when the valid data region timing signal DE is turned on (e.g., the distance d3 is 0); that is to say, when the first display driver (e.g., the gate driver) is turned on, the first horizontal line will display the valid data region, which moves 12 horizontal lines upward than the normal display region, so that the display region DA moves up, and the position of the display region DA can be fine-tuned upward.

In summary, the panel display position fine adjustment method according to the invention can achieve fine adjustment of the position of the display region DA up and down.

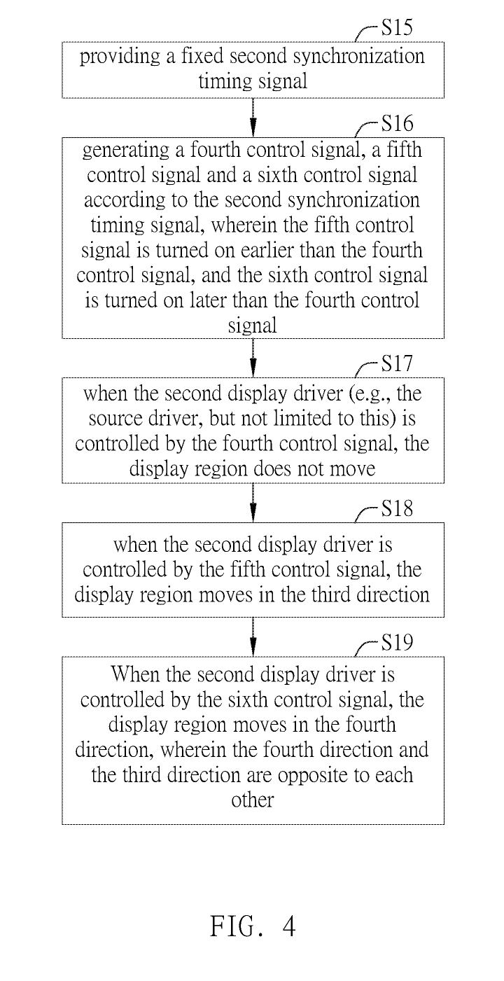

Next, as shown in FIG. 4, the panel display position fine adjustment method can further include the following steps:

Step S15: providing a fixed second synchronization timing signal;

Step S16: generating a fourth control signal, a fifth control signal and a sixth control signal according to the second synchronization timing signal, wherein the fifth control signal is turned on earlier than the fourth control signal, and the sixth control signal is turned on later than the fourth control signal;

Step S17: when the second display driver (e.g., the source driver, but not limited to this) is controlled by the fourth control signal, the display region does not move;

Step S18: when the second display driver is controlled by the fifth control signal, the display region moves in the third direction; and

Step S19: When the second display driver is controlled by the sixth control signal, the display region moves in the fourth direction, wherein the fourth direction and the third direction are opposite to each other.

In practical applications, the first display driver can be a source driver; the second synchronization timing signal can be a horizontal synchronization timing signal; the third direction is toward the right side of the panel and the fourth direction is toward the left side of the panel; the distance that the display region in step S18 moves along the third direction is equal to the distance that the display region in step S19 moves along the fourth direction.

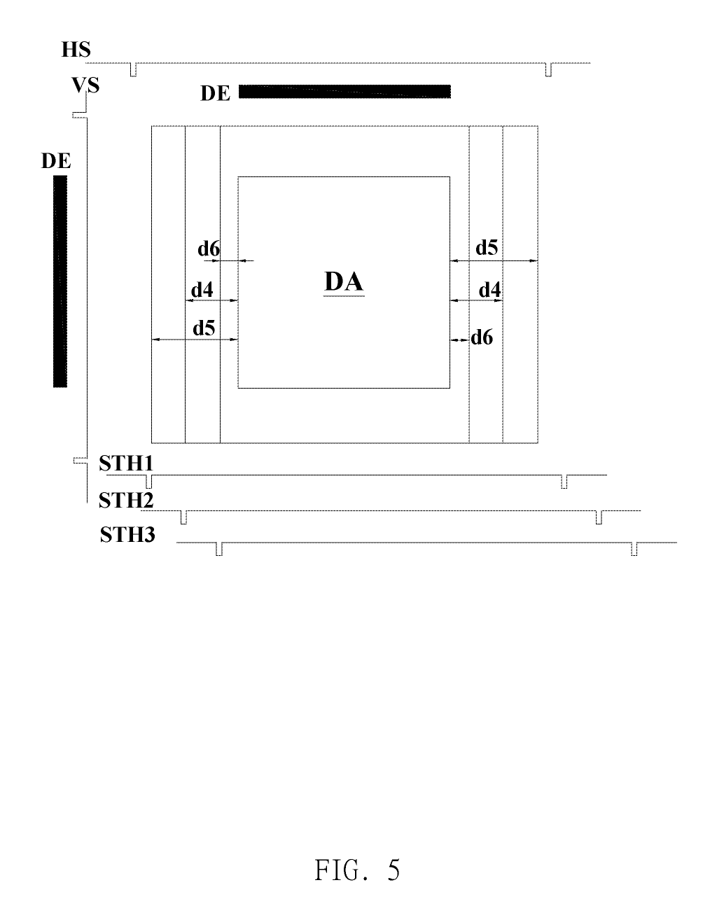

For example, please refer to FIG. 5. FIG. 5 illustrates a schematic diagram of generating a fourth control signal, a fifth control signal, and a sixth control signal according to the second synchronization timing signal to control the operation of the second display driver to make the display region not move, move right and move left respectively.

As shown in FIG. 5, assuming that the timing controller in the display can provide a fixed second synchronization timing signal HS, the panel display position fine adjustment method generates the fourth control signal STH1, the fifth control signal STH2 and the sixth control signal STH3 according to the second synchronization timing signal HS. Assuming that the time is increased from the left side to the right side, the on-time of the fifth control signal STH2 is earlier than the on-time of the fourth control signal STH1 and the on-time of the sixth control signal STH3 is later than the on-time of the fourth control signal STH1.

When the second display driver (e.g., the source driver) is turned on controlled by the on-time of the fourth control signal STH1, the second display driver (e.g., the source driver) is turned on at a distance d4 (e.g., 12 pixels) before the valid data region timing signal DE; that is to say, when the second display driver (e.g., the source driver) is turned on, the valid data region is displayed after 12 pixels, which is the normal display area, so that the display region DA does not move.

When the second display driver (the source driver) is turned on controlled by the on-time of the fifth control signal STH2, the second display driver (e.g., the source driver) is turned on at a distance d5 (e.g., 24 pixels) before the valid data region timing signal DE; that is to say, when the second display driver (e.g., the source driver) is turned on, the valid data area is displayed after 24 pixels, which moves 12 pixels to the right side than the normal display region. The display region DA is moved to the right side, so that the position of the display region DA can be finely adjusted to the right side.

When the second display driver (e.g., the source driver) is turned on controlled by the on-time of the sixth control signal STH3, the second display driver (e.g., the source driver) is turned on only when the valid data region timing signal DE is turned on (e.g., the distance d6 is 0); that is to say, when the second display driver (e.g., the source driver) is turned on, the first pixel will display the valid data region, which moves 12 pixels to the left side than the normal display region, so that the display region DA moves to the left side, so that the position of the display region DA can be fine-tuned to the left side.

In summary, the panel display position fine adjustment method according to the invention can realize the leftward and rightward fine adjustment of the position of the display region DA.

Compared to the prior art, the panel display position fine adjustment method of the invention can finely adjust the position of the display region in the up, down, left and right directions, so that the display area deviation caused by the inaccuracy of the conventional micro display can be effectively improved, thereby when the micro display displays image, the problems caused by the influence of the display region offset can be avoided.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A panel display position fine adjustment method, applied to a panel comprising a display region, the panel being coupled to a first display driver, the panel display position fine adjustment method comprising steps of:
(a) providing a fixed first synchronization timing signal;
(b) generating a first control signal, a second control signal and a third control signal according to the first synchronization timing signal, wherein the second control signal is turned on earlier than the first control signal and the third control signal is turned on later than the first control signal;
(c) when the first display driver is controlled by the first control signal, the display area being not moved;
(d) when the first display driver is controlled by the second control signal, the display area being moved in the first direction; and
(e) when the first display driver is controlled by the third control signal, the display area being moved in the second direction opposite to the first direction.

2. The panel display position fine adjustment method of claim 1, wherein the first display driver is a gate driver.

3. The panel display position fine adjustment method of claim 1, wherein the first synchronization timing signal is a vertical synchronization timing signal.

4. The panel display position fine adjustment method of claim 1, wherein the first direction is toward a bottom of the panel and the second direction is toward a top of the panel.

5. The panel display position fine adjustment method of claim 1, wherein a distance that the display region moves along the first direction in the step (d) is equal to a distance that the display region moves along the second direction in the step (e).

6. The panel display position fine adjustment method of claim 1, wherein the panel is further coupled to a second display driver, the panel display position fine adjustment method further comprises steps of:
(f) providing a fixed second synchronization timing signal;
(g) generating a fourth control signal, a fifth control signal and a sixth control signal according to the second synchronization timing signal, wherein the fifth control signal is turned on earlier than the fourth control signal and the sixth control signal is turned on later than the fourth control signal;
(h) when the second display driver is controlled by the fourth control signal, the display area being not moved;
(i) when the second display driver is controlled by the fifth control signal, the display area being moved in a third direction; and
(j) when the second display driver is controlled by the sixth control signal, the display area being moved in a fourth direction opposite to the third direction.

7. The panel display position fine adjustment method of claim 6, wherein the second display driver is a source driver.

8. The panel display position fine adjustment method of claim 6, wherein the second synchronization timing signal is a horizontal synchronization timing signal.

9. The panel display position fine adjustment method of claim 6, wherein the third direction is toward a right side of the panel and the second direction is toward a left side of the panel.

10. The panel display position fine adjustment method of claim 6, wherein a distance that the display region moves along the third direction in the step (i) is equal to a distance that the display region moves along the fourth direction in the step (j).

11. The panel display position fine adjustment method of claim 1, further comprising a step of:
providing a fixed effective data region timing signal.
